(19) United States
(12) Patent Application Publication
(10) Pub. No.: US 2015/0090538 A1
(43) Pub. Date: Apr. 2, 2015

(54) BRAKE PAD ASSEMBLY WITH WEAR INDICATOR

(71) Applicant: Wayne-Ian Moore, Changhua County (TW)

(72) Inventor: Wayne-Ian Moore, Changhua County (TW)

(21) Appl. No.: 14/042,733

(22) Filed: Oct. 1, 2013

(51) Int. Cl. F16D 66/02; F16D 65/84; F16D 65/092

(52) U.S. Cl. CPC F16D 66/02; F16D 65/092; F16D 65/84
USPC 188/1.11 W

(57) ABSTRACT

A brake pad assembly includes a backing plate, a brake lining and a brake wear indicator. The brake lining is disposed on a front side of the backing plate for engagement with a rotor to be braked. The brake wear indicator is formed of an elastic metallic strip with one end attached to the front side of the backing plate. Moreover, the brake wear indicator is disposed adjacent to the brake lining for engagement with the rotor to be braked once the brake lining is worn out to a predetermined safe thickness, and thereby causing an annoying noise to alert an motorist that the brake pad assembly needs to be replaced.

### BACKGROUND OF THE INVENTION

1. Field of the Invention

The present invention relates to a brake pad assembly and more particularly to a brake pad assembly with a wear noise indicator which generates annoying noise, during braking, to alert the motorist that brake servicing is required.

2. Description of the Related Art

As is known, the brake linings of brake pads are subject to operation-induced wear which should be monitored for reasons of operational safety, with the result that the brake pad can be replaced at the latest when a minimum thickness of the brake lining has been reached.

Many solutions have been found to monitor the wear of the brake lining One known solution is to embed fine metal particles in the friction ceramic material of the brake lining such that as the brake lining is gradually worn out, the fine metal particles will first come into contact with the brake rotor to cause an annoying squeal to alert the motorist that the brake pad needs to be replaced.

Another solution is to incorporate a metal tang into the brake lining. The metal tang contacts the rotor when the lining is worn out, causing an annoying squeal. The annoying squeal caused by the warning tang is the typical alert that the brake pads need to be replaced; if the squeal is ignored for too long, a rotor damage will be the typical result.

### SUMMARY OF THE INVENTION

It is an object of the present invention to provide a brake pad assembly with a different wear indicator.

It is another object of the present invention to provide a brake pad assembly with a heat sink into which the wear indicator is incorporated.

According to the invention, the brake pad assembly includes a backing plate, a brake lining disposed on a front side of the backing plate for engagement with a rotor to be braked, and a brake wear indicator formed of an elastic metallic strip with one end attached to the front side of the backing plate. The brake wear indicator is disposed adjacent to the brake lining for engagement with the rotor to be braked once the brake lining is worn out to a predetermined minimum thickness, causing an annoying noise to alert an motorist that the brake pad assembly needs to be replaced.

Preferably, a heat sink is included in the brake pad assembly. The heat sink has a thermal conductive sheet and a set of cooling fins disposed on a rear side of the thermal conductive sheet. The thermal conductive sheet is overlapped on the front side of the backing plate, and the brake wear indicator extends integrally from the thermal conductive sheet.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a brake pad assembly in accordance with the preferred embodiment of the present invention;

FIG. 2 is an exploded perspective view of the brake pad assembly shown in FIG. 1;

FIG. 3 is a cross-sectional view of the brake pad assembly shown in FIG. 1, taken along the line III-III; and

FIG. 4 is a cross-sectional view of the brake pad assembly shown in FIG. 1, taken along the line IV-IV.

### DETAILED DESCRIPTION OF EMBODIMENTS

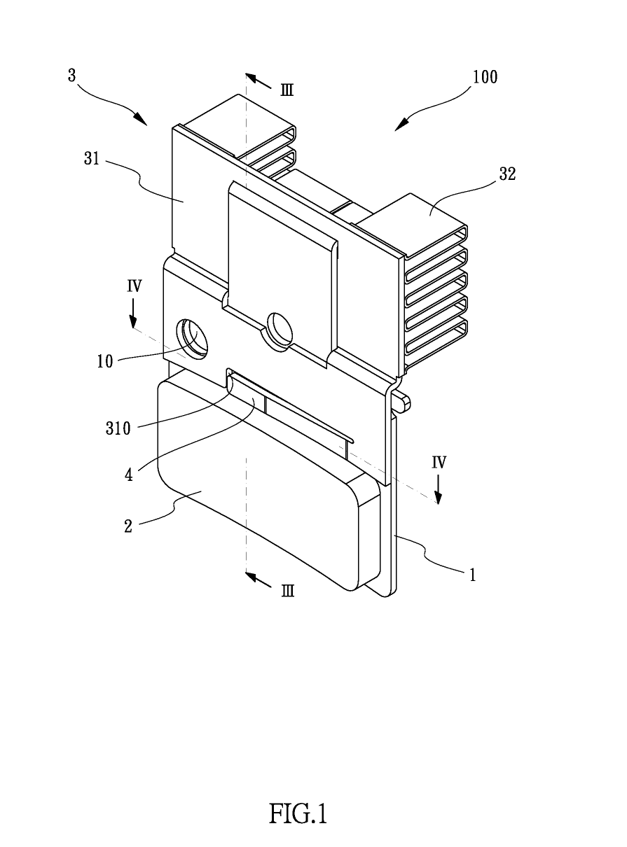

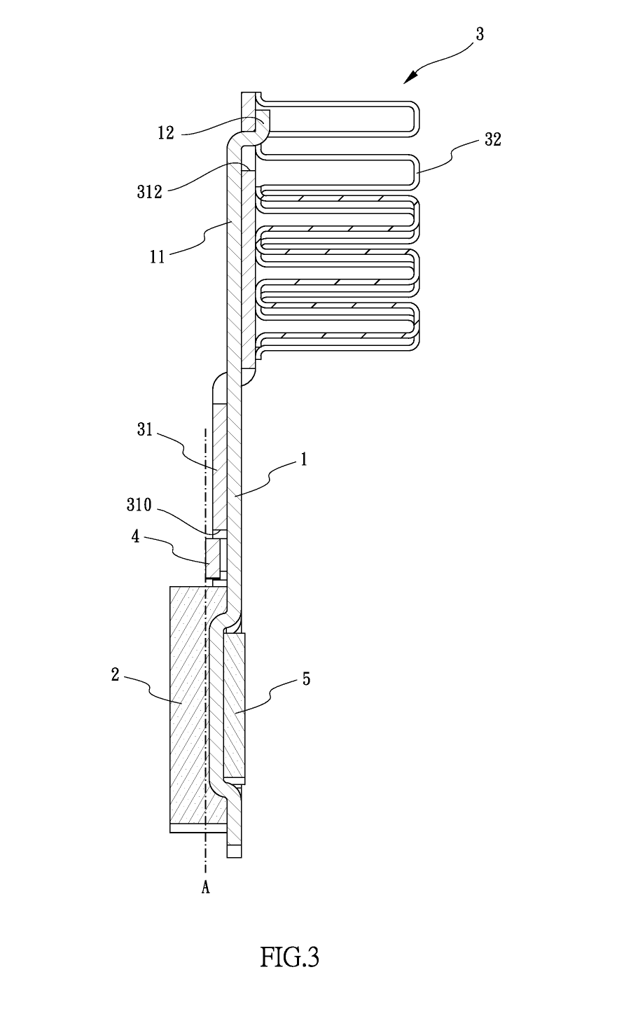

A brake pad assembly 100 according to the preferred embodiment of this invention is shown in FIGS. 1 through 4. In general, the brake pad assembly 100 includes a backing plate 1, a brake lining 2 disposed on a front side of the backing plate 1 for engagement with a rotor to be braked, a heat sink 3 releasably fastened to the backing plate 1, a brake wear indicator 4 and a thermal insulation pad 5 (FIG. 3) disposed on a rear side of the backing plate 1.

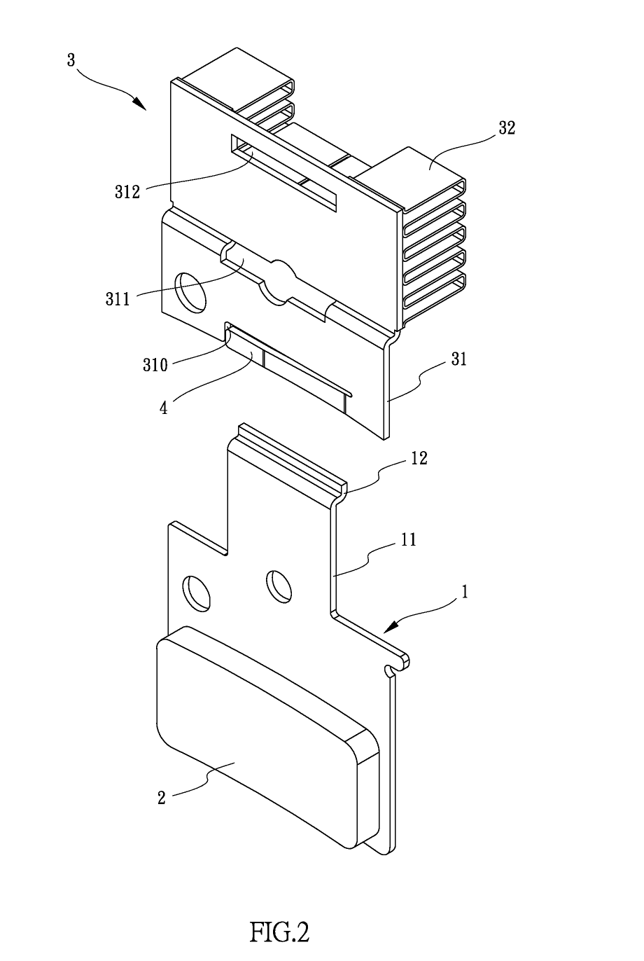

FIG. 2 illustrates that the heat sink 3 is released from the backing plate 1. As shown, the heat sink 3 includes a thermal conductive sheet 31 made of metal and a set of cooling fins 32 disposed on a rear side of the thermal conductive sheet 31. The brake wear indicator 4 is formed of an elastic metallic strip with one end attached to the front side of the backing plate 1, as shown in FIG. 1. Specifically, the brake wear indicator 4 extends integrally from the thermal conductive sheet 31 that is overlapped on the front side of the backing plate 1. Heat generated by the braking lining 2 during braking can be transferred through the backing plate 1 to the heat sink 3 for heat dissipation. Moreover, the backing plate 1 and the thermal conductive sheet 31 together defines a pin hole 10 for installation of the brake pad assembly 100 onto a caliper of a disk brake system of a vehicle.

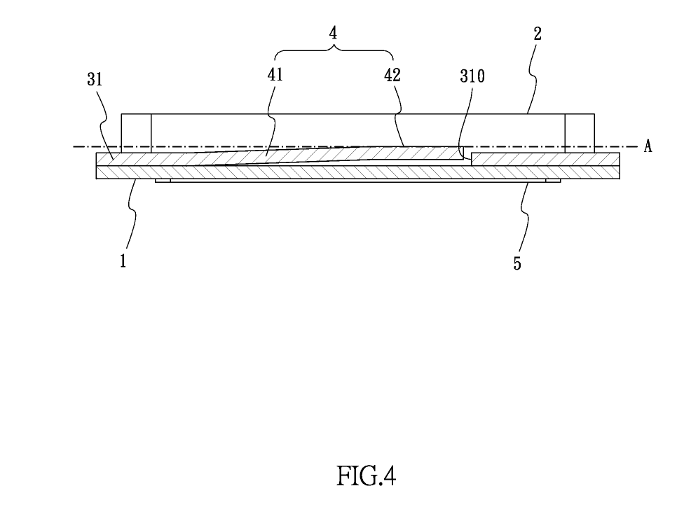

As shown in FIG. 1, the thermal conductive sheet 31 of the heat sink 3 defines a notch 310 next to the brake lining 2. For a visually integrated appearance, the brake wear indicator 4 is substantially disposed in the notch 310 of the thermal conductive sheet 31 with one end extending from an inner wall of the notch 310. As shown in FIG. 3 or 4, a virtual safety plane A is defined to determine a minimum thickness of the brake lining 2, for the sake of operational safety. The brake wear indicator 4 linearly extends in a direction parallel to a side surface of the brake lining 2 and protrudes a distance from the backing plate 1 to the safety plane A. That is, the brake wear indicator 4 is disposed adjacent to the brake lining 2 for engagement with the rotor to be braked as soon as the brake lining 2 is worn out to the predetermined minimum thickness, and thereby causing an annoying noise to alert an motorist that the brake pad assembly 100 needs to be replaced.

As shown in FIG. 4, the brake wear indicator 4 is formed of the elastic metallic strip which has an inclined section 41 extending integrally from the inner wall of the notch 310 of the thermal conductive sheet 31, and a flat section 42 extending from the inclined section 41 and flushing with the safety plane A. Being formed of the elastic metallic strip, the brake wear indicator 4 has an elasticity suitable for contact with the rotor during braking to give a wear alarm to the motorist but cause no harm to the rotor.

As shown in FIG. 2, the thermal conductive sheet 31 along with the set of the cooling fins 32 is releasably fastened to the backing plate 1. The thermal conductive sheet 31 defines an insertion slot 11 and a fastening slot 12 for insertion of a tongue portion 11 and a hook portion 12 of the backing plate 1. As shown in FIG. 1 or 3, the thermal conductive sheet 31 and the backing plate 1 can be easily and quickly fastened to each other for use. Alternatively, if a wear alarm is given by the brake wear indicator 4, the thermal conductive sheet 31 can also be released quickly from the backing plate 1, as shown in FIG. 2, and kept to couple with a new set of backing plate and brake lining for another use.

It is to be understood that the disclosed embodiments are illustrative in nature and the invention is not to be limited to any one or more embodiments except as set forth in the following claims.

What is claimed is:

1. A brake pad assembly comprising:
a backing plate;
a brake lining disposed on a front side of the backing plate for engagement with a rotor to be braked; and
a brake wear indicator formed of an elastic metallic strip with one end attached to the front side of the backing plate, wherein the brake wear indicator is disposed adjacent to the brake lining for engagement with the rotor to be braked once the brake lining is worn out to a predetermined minimum thickness, and thereby causing an annoying noise to alert an motorist that the brake pad assembly needs to be replaced.

2. The brake pad assembly of claim 1, further comprising a heat sink having a thermal conductive sheet, wherein the thermal conductive sheet is overlapped on the front side of the backing plate, and the brake wear indicator extends integrally from the thermal conductive sheet.

3. The brake pad assembly of claim 2, wherein the thermal conductive sheet of the heat sink defines a notch next to the brake lining, and the brake wear indicator is substantially disposed in the notch of the thermal conductive sheet with one end extending from an inner wall of the notch of the thermal conductive sheet.

4. The brake pad assembly of claim 3, wherein the thermal conductive sheet is releasably fastened to the backing plate.

5. The brake pad assembly of claim 4, wherein the heat sink further includes a set of cooling fins mounted on a rear side of the thermal conductive sheet.

6. The brake pad assembly of claim 3, wherein the brake wear indicator linearly extends in a direction parallel to a side surface of the brake lining.

7. The brake pad assembly of claim 6, wherein the brake wear indicator is formed of the elastic metallic strip which has an inclined section extending integrally from the inner wall of the notch of the thermal conductive sheet and a flat section extending from the inclined section.

8. The brake pad assembly of claim 2, wherein the heat sink further includes a set of cooling fins mounted on a rear side of the thermal conductive sheet.

9. The brake pad assembly of claim 8, wherein the thermal conductive sheet is releasably fastened to the backing plate.

10. The brake pad assembly of claim 2, wherein the thermal conductive sheet and the backing plate together define a pin hole.
